(19) United States
(12) Patent Application Publication
(10) Pub. No.: US 2017/0043948 A1
(43) Pub. Date: Feb. 16, 2017

(54) Magnetic Retention Device

(71) Applicant: Nathan James Badger, Meridian, ID (US)

(72) Inventor: Nathan James Badger, Meridian, ID (US)

(21) Appl. No.: 14/826,126

(22) Filed: Aug. 13, 2015

(51) Int. Cl. B65F 1/06; F16B 1/00

(52) U.S. Cl. CPC B65F 1/06; F16B 1/00; F16B 2001/0035

(57) ABSTRACT

A Magnetic Retention Device comprising an elongated, pliant strap with a magnet set at each end that magnetically associate with each other. The magnet ends of the Magnetic Retention Device secure a flexible bag inside a waste container by magnetic association through the side of the waste container and side of flexible bag. A plurality of Magnetic Retention Devices can be used to secure two or more sides of the flexible bag to the inside of the waste container. The Magnetic Retention Device can serve as a handle to a single side of a flexible bag in order to hang the bag from a rigid arm.

### BACKGROUND

The invention relates to a device for retaining a flexible bag in a container.

Flexible plastic bags are often used to line waste containers. The top edge of a re-useable plastic bag or a plastic liner is folded over the rim of the waste container. However, the fitting is not secure and any noticeable weight of waste placed in the bag tends to release the plastic bag or liner from the rim of the waste container, thereby causing the bag to collapse at the bottom of the container. The present invention secures the flexible plastic bag or liner to the waste container with magnets that are attached to each end of a pliant strap and these magnet sets magnetically associate with each other through the container or directly to a metal container.

Attempts using rigid circular retention devices to secure a bag to a container can be found in U.S. Pat. No. 3,815,778, U.S. Design Pat. No. 457,283, and U.S. Design Pat. No. 484,660. However each of these has a disadvantage of being restricted to a circular-shaped container. Flexible rings that circle the outside of the container to secure the bag are disclosed in U.S. Pat. No. 3,927,445 and U.S. Design Pat. No. 386,867. The flexible ring can be a disadvantage if the container narrows in diameter at the base, thereby allowing the ring to slip down the container and releasing the bag.

Using a clamp to secure a bag liner or flexible bag to a container allows flexibility of size and shape of container as demonstrated in U.S. Pat. No. 5,735,495 and U.S. Pat. No. 6,484,374. However, a disadvantage of a clamp or clip is that the type of container is restricted to a given thickness of its side to accommodate the clip or clamp.

Using a magnet association to retain a bag inside a container has been disclosed in U.S. Pat. No. 8,028,380. However, a disadvantage of the device disclosed in this reference may be the requirement that one of the magnets is permanently affixed to the container. Many waste containers are not suitable for permanently affixing a retention device to hold a bag in place.

For the foregoing reasons, there is a need for a pliant, self-affixing device for securing a bag or liner inside a waste container that may be any size or shape and made of any type of material, for example, plastic or metal.

### SUMMARY

The present invention satisfies the needs for a secure, pliant device that is also removable to retain a bag within a container without slipping when the bag is filled. A Magnetic Retention Device having the features of the present invention comprises a self-affixing, magnetically-associated device with a magnet set at each end of a pliant strap. The two magnet sets connected by a pliant strap magnetically associate and between this association secure material in a stationary position (the flexible bag liner and side of the container). The pliant strap can be placed over any thickness of side of any container to secure the flexible bag to the container with the magnetically associated magnet sets. The Magnetic Retention Device can be used with a metal waste container by using the elongated version of the Magnetic Retention Device in which the magnets associate with the metal of the container and secure the flexible bag between the Magnetic Retention Device and the container.

A second aspect of this invention is the method for securing a flexible bag to a container using the Magnetic Retention Device disclosed.

A third aspect of this invention is the method for adding a handle to a flexible bag with the Magnetic Retention Device disclosed so that the bag may be held open and hung from a rigid arm.

### DRAWINGS

These and other features, aspects, and advantages of the present invention will become better understood with reference to the following description, appended claims, and accompanying drawings where

FIG. 1 shows a perspective view of the Magnetic Retention Device in the folded position to retain a flexible bag to the side of a container;

FIG. 2A shows a top view and FIG. 2B shows a bottom view of the unfolded Magnetic Retention Device;

FIG. 3 shows a top view of a folded Magnetic Retention Device in which magnets are associated;

FIG. 4 shows an environmental view of Magnetic Retention Device in use to secure flexible bag to waste container;

FIG. 5 shows an environmental view of the Magnetic Retention Device in the elongated position in use on a metal waste container to secure a flexible bag inside a metal waste container; and,

FIG. 6 shows an environmental view of the Magnetic Retention Device in use as a handle for a flexible bag.

### DESCRIPTION

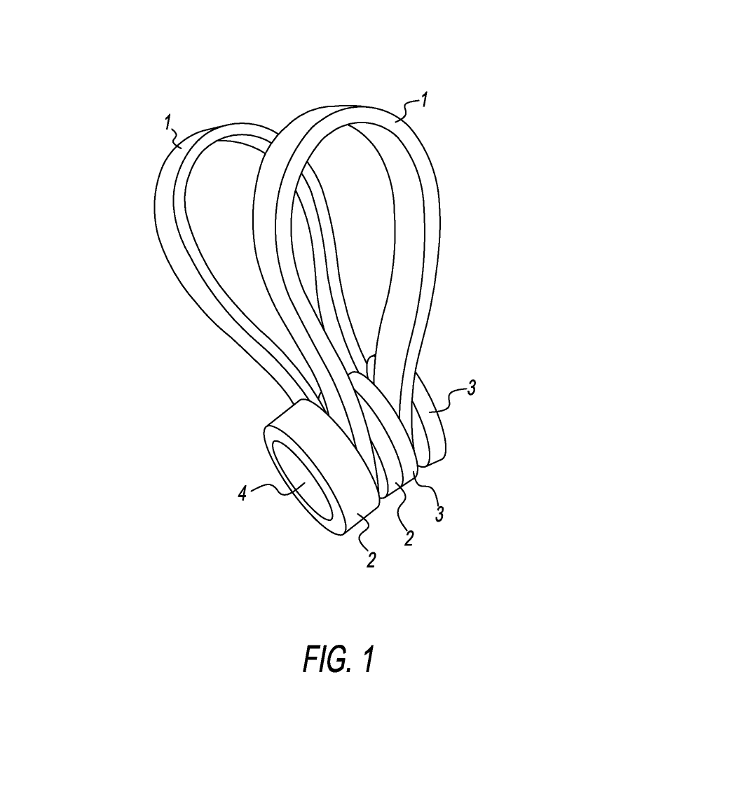

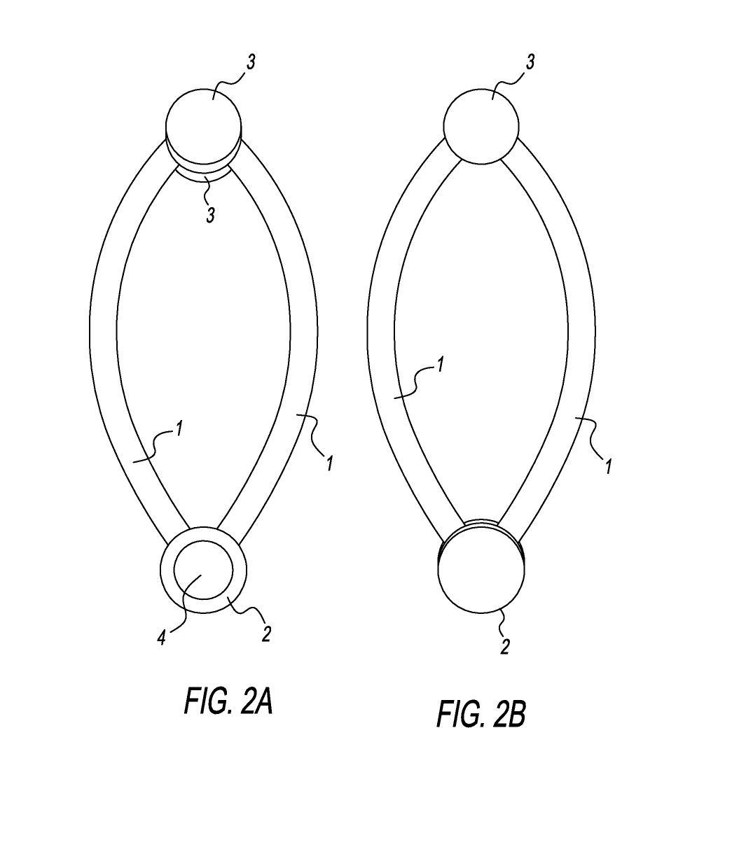

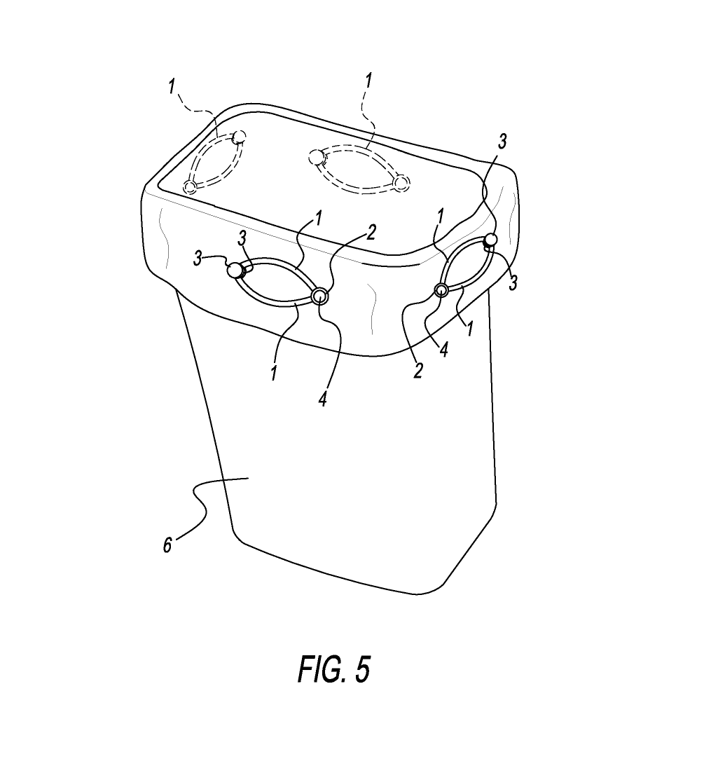

The present invention is directed to a Magnetic Retention Device that can secure a flexible bag, such as a reusable plastic bag or a bag liner, inside a container, such as a waste container or a trash can. With reference to the drawings, the Magnetic Retention Device can be used in a folded position (FIGS. 1, 3, 4, and 6) or used in elongated position (FIG. 2A, FIGS. 2B, and 5).

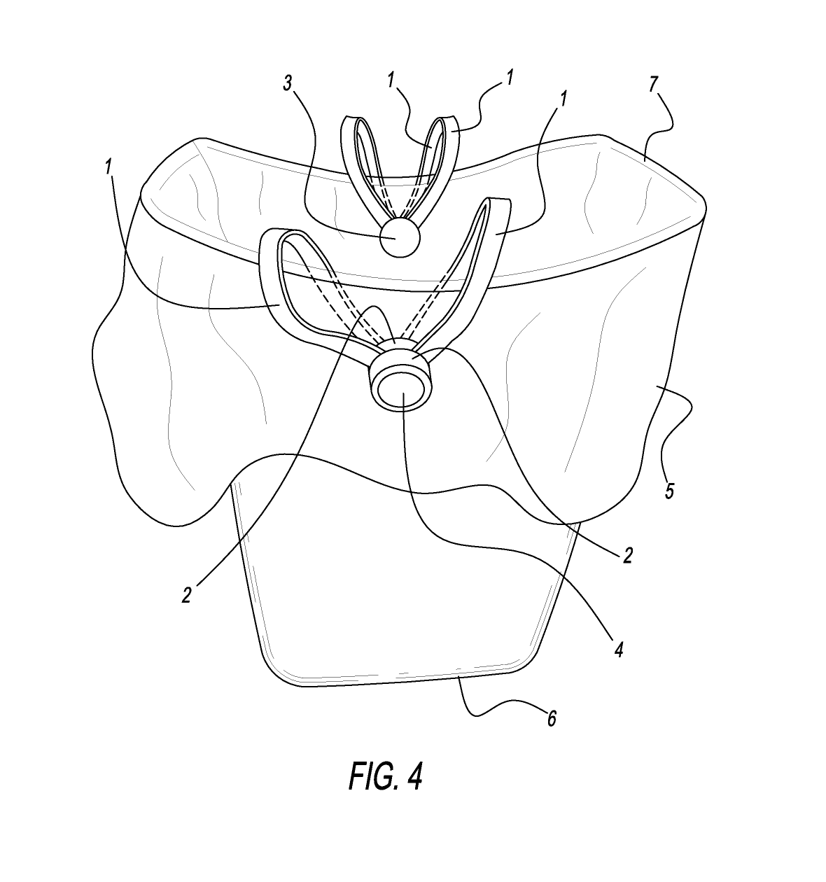

As shown in FIG. 1, a Magnetic Retention Device in the folded position comprises two magnet sets (2, 3) that magnetically associate with each other and are connected by a pliant strap 1. The pliant strap 1 allows the two magnet ends to be placed on opposite sides of a single side of the container with a flexible bag in between as shown in FIG. 4. The magnet ends 2 and 3 associate with each other and secure the bag to the side of the container.

In the present version of the Magnetic Retention Device, in the folded position as shown in FIG. 1, the magnet ends 2 and 3 are comprised of two magnets stacked in the north pole to south pole configuration (north-south) with the north pole being on the outer side where the decorative cover 4 is placed. As shown in the folded position in FIG. 1, all four magnets are stacked in the same orientation of north-south such that the magnets attract each other and form a secure association.

As shown in FIG. 2A and FIG. 2B, the present version of the Magnetic Retention Device is in the elongated position wherein the two magnet ends 2 and 3 are positioned at opposite ends of the pliant strap 1. In the top view of the elongated Magnetic Retention Device (FIG. 2A) the two magnets of the first magnet end 2 are in the north-south configuration and the two magnets of the second magnet end 3 are in the south-north configuration (south pole facing). Likewise, in the bottom view of the elongated Magnetic Retention Device (FIG. 2B) shows the south-north configuration of the magnets of the first magnet set 2 (south facing) and the second magnet end 3 is in the north-south configuration. In these positions, the magnet end 2 associates with magnet end 3 when the Magnetic Retention Device is in the folded position as shown in FIG. 1. In an alternative version of the invention, all four magnets can be placed in the reverse orientation such that in the bottom view of the elongated position, the first magnet set 2 north-south configuration and the second magnet set 3 is in the south-north position, likewise the top view of the elongated version has the first magnet set 2 in the south-north configuration and the second magnet set 3 in the north south configuration. The folded position of the alternative version of the invention has all four magnets in line in the south-north position. The four magnets attract with each other and form a strong magnetic association.

The shape and size of the magnets used in the magnet sets are not restricted to any specific dimension or shape for the Magnetic Retention Device to be used to secure a bag to a container. In the present version of the invention, the size and shape of the magnets used in the first magnet 105 end 2 and the second magnet end 3 are circular and one inch in diameter. A decorative magnet cover 4 as shown in FIG. 2A in the present version of the invention may be added to the outer magnet of the first magnet end 2. The decorative cover 4 of the outer magnet of the first magnet end 2 is for decoration and does not contribute to the function of the device.

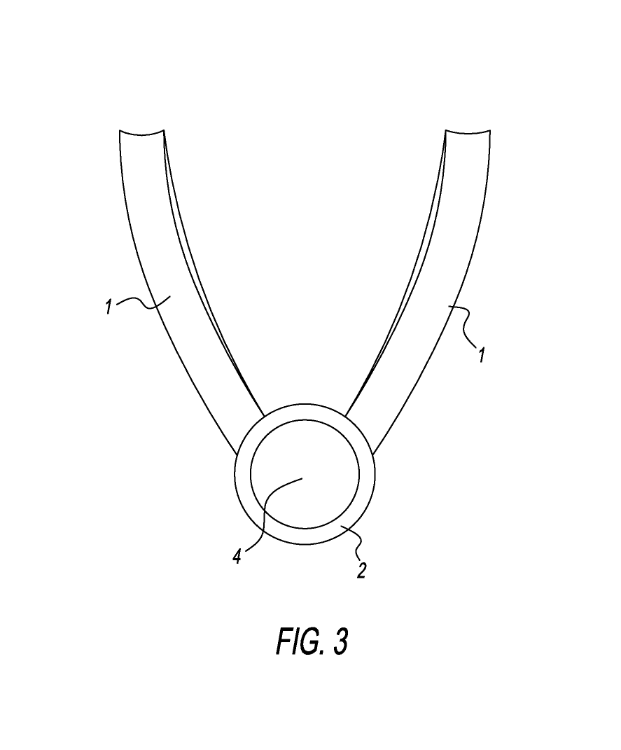

The strap 1 is made of pliant, resilient material such as rubber as used in the present version of this invention (FIG. 1). The material of strap 1 is pliant in order to bend into a folded position as shown in FIG. 1 and FIG. 3. The pliant strap 1 connecting the first magnet set 2 to the second magnet set 3 may be comprised of one or two straps as shown in the present version of the invention in FIGS. 2A and 2B. The pliant strap has a length of at least 1 inch and no greater than 12 inches, and preferably at least 4 inches and preferably no greater than 6 inches. The pliant 115 strap 1 is joined to the first magnet end 2 and the second magnet end 3 with adhesive between the two magnets of each set. In the present version of the invention, the ends of the pliant strand 1 is joined in a permanent manner to the first magnet end 2 and the second magnet end 3 with thermoplastic adhesive, or other suitable adhesives such as glue.

A plurality of Magnetic Retention Devices can be used to secure a flexible bag whose top 120 edge folds over the rim of a container, such as a waste container, as shown in FIG. 4. The top edge of the flexible bag 5 is folded over the rim 7 of the waste container 6. The first magnet end 2 with the decorative outer magnet 4 is placed on the outside of the flexible bag 5 on the outside of the waste container 6. The pliant straps 1 are folded over the rim 7 of the waste container 6 allowing the magnet end 3 on the second end of the pliant strap 1 to position itself on the inside 125 of the container and magnetically associate with the magnet end 2 on the first end of the pliant strap 1 positioned on top edge of the flexible bag 5 on the outside of the waste container 6. The magnet ends associate to secure the bag liner 5 to the side of the waste container 6. For an optimal secure fit of the flexible bag to the waste container, a second Magnetic Retention Device can be positioned on the opposite side of the waste container as shown in FIG. 4. The first 130 magnet end 2 with the decorative outer magnet 4 is placed on the outer side of the waste container with the flexible bag 5 between the magnet set and the side of the waste container 6. The pliant strap 1 is folded over the rim 7 and inside the waste container 6 thereby allowing the second magnet end 3 to position on the inside of the opposite side of the container and magnetically associate with the first magnet set 2. For larger waste containers with more volume 135 of waste, more than two Magnetic Retention Devices can be used to secure the bag liner to the container.

If the flexible bag is of a smaller size that does not allow the top edge to fold over the rim of the waste container, the Magnetic Retention Device will hold the bag secure within the container without the bag folding over the rim of the container. Two Magnetic Retention Devices placed 140 in position on opposite sides of a waste container, will secure the flexible bag to the inside of the side of the container with the second magnet set as it associates with the first magnet set that is positioned on the outside of the waste container.

The Magnetic Retention Device can be used on a metal waste container in the elongated position of this version of the invention (FIG. 5). The top edge of the flexible plastic bag 5 is folded over the rim 7 of the waste container 6 and the Magnetic Retention Device is affixed on side of the flexible plastic bag on the outside of the waste container in the elongated position so that both the first magnet end 2 and the second magnet end 3 associate magnetically with the metal of the side of the waste container 7. A second Magnetic Retention Device can be affixed in the elongated position on the side of the flexible bag on the outside of the opposite side of the 150 waste container 7.

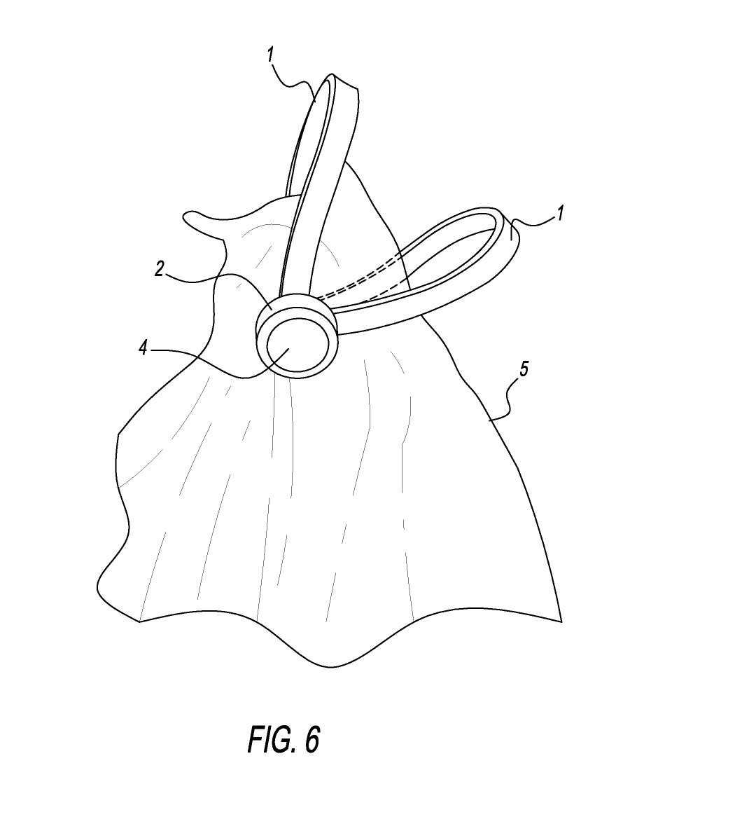

The Magnetic Retention Device can be used as a handle to hold open a flexible bag as shown in FIG. 6. The first magnet end 2 with the decorative cover 4 is visible on the outside of the flexible bag 5. The pliant strap 1 folds into the flexible bag 5 thereby positioning the second magnet end 3 inside the flexible bag and allowing the second magnet end (not visible) to 155 magnetically associate through the side of the flexible bag with the first magnet end 2. The folded pliant strap 1 can now function as a handle for the bag. The bag with a handle formed with a Magnetic Retention Device can be hung in the open position from a rigid arm, such as a hook, rod, or branch.

The previously described versions of the present invention have many advantages, including 160 the following. The pliant material of the strap, in this version rubber, that connects the two magnetic ends secures a flexible bag inside a waste container of any size and shape. The pliant strap folds over the top rim of the waste container so that the two magnetic ends can associate with each other through the side of the waste container and the side of the flexible bag providing a secure retention of the bag to any size waste container. In addition, the present version of the 165 invention is self-affixing and removable from the waste container that provides convenience for use.

Although the present invention has been described in considerable detail with reference to certain preferred versions thereof, other versions are possible. For example, the Magnetic Retention Device can be used to hold papers together, to hold clothes onto a hanger, to hang 170 clothing from a line or hook, to hang a sign on a metal post, to hang a sign over a rigid arm, and, to hang a tool over a rigid arm. The present version of the Magnetic Retention Device is not limited to the embodiments described above, but encompasses any and all embodiments within the scope of the following claims.

### REFERENCES CITED

### U.S. Patent Documents

| Patent No. | Issue Date | Inventor(s) |
|---|---|---|
| 3,815,778 | Jun. 11, 1974 | Martin |
| D457,283 | May. 14, 2002 | Wayt |
| D484,660 | Dec. 30, 2003 | Robbins |
| 3,927,445 | Dec. 23, 1975 | Pavlish |
| D386,867 | Nov. 25, 1997 | Clark |
| 5,735,495 | Apr. 7, 1998 | Kubota |
| 6,484,374 | Nov. 26, 2002 | McAllister |
| 8,028,380 | Oct. 4, 2011 | Lin |

I claim:

1. A Magnetic Retention Device for retaining a bag to inside a container, the device comprising:
a first magnet end,
a second magnet end, and
a pliant strap that connects the first magnet end and the second magnet end.

2. The device as in claim 1 wherein there is one or more elongated, pliant straps joining the first magnet end to the second magnet end.

3. The device as in claim 1 wherein the pliant strap is rubber.

4. The device as in claim 1 wherein the pliant strap has a length between 4 to 6 inches.

5. The device as in claim 1 wherein the magnet ends are between 0.5 to 2 inches in diameter.

6. The device as in claim 1 wherein the outer magnet of the first magnet end is decorative.

7. A method for retaining a flexible bag inside a container, the method comprising,
placing a flexible bag inside a container,
folding a upper edge of the flexible bag over the container,
placing a first magnet end of a Magnetic Retention Device on an outside surface of the container,
folding the Magnetic Retention Device over the top of the container,
placing a second end of the Magnetic Retention Device on the flexible bag against an inside surface of the container, and
repeating the steps of placing a second Magnetic Retention Device to secure the other side of the flexible bag to an opposite side of the container.

8. A method for adding a handle to a flexible bag, the method comprising,
placing a first magnet end of a Magnetic Retention Device on an outside surface of a flexible bag,
folding a strap of the Magnetic Retention Device to inside the flexible bag,
placing a second magnet end on an inside surface of the flexible bag so that the first magnet end attaches to the second magnet end through the flexible bag, and
using the loop formed by the folded strap to hang the flexible bag from a rigid arm.
